(19) United States
(12) Patent Application Publication
(10) Pub. No.: US 2007/0087089 A1
(43) Pub. Date: Apr. 19, 2007

(54) Bacon package and foam stiffner for use therein

(75) Inventors: Peter Heymann, Dusseldorf (DE); Alan P. Jones, Signal Mountain, TN (US)

Correspondence Address: EMCH, SCHAFFER, SCHAUB & PORCELLO CO, P O BOX 916, ONE SEAGATE SUITE 1980, TOLEDO, OH, 43697, US

(73) Assignee: GerroPlast GmbH

(21) Appl. No.: 11/544,486

(22) Filed: Oct. 5, 2006

Related U.S. Application Data
(60) Provisional application No. 60/727,775, filed on Oct. 18, 2005.

(51) Int. Cl. A23B 7/148

(52) U.S. Cl. 426/106

(57) ABSTRACT

A bacon package has a stiffener sheet formed of plastic having an inner layer of foam polystyrene and solid films of polystyrene on opposite sides of the foam layer and coextruded therewith to form a web. The web of coextruded plastic is fed through an embossing station which forms an embossment defining the outer periphery of the stiffener sheet and, if desired, a plurality of annular embossments within the periphery. The embossed extrudate is then cut with heated knives around each embossment to seal the edges defined by the embossments. Apparatus other than heated knives may be used for sealing the edges.

### CROSS REFERENCE TO RELATED APPLICATION

This application is based on and claims the benefit of provisional application No. 60/727,775 filed Oct. 18, 2005.

### BACKGROUND OF THE INVENTION

The present invention relates to a new and improved package for bacon and to a stiffener board for use therein. The package of the present invention has a number of advantages over the present paper board product used for packaging bacon. The bacon package presently on the market uses a wood fiber board material that is laminated on both the upper and lower surfaces with a plastic sheet. The lower surface is pigmented (black, yellow, or other color). The upper film is either printed on the top surface or reversed printed to show through the clear film of the lamination. The package is finished by punching the perimeter and a number of windows to allow the marble of the bacon to show through for observation by the customer.

The laminated and printed board is folded around the bacon and the total package is then vacuum sealed with a clear film.

The use of fiber board in the present packages for bacon leads to a number of problems that the present invention solves.

The problems with the prior packages include:

The fibers in the edge of the board sometimes poke through the vacuum shrink film allowing air to enter the package. If this happens on the packing line, the bacon can be recycled and the value saved. If the leak is missed by the packer or is a slow leak that shows up at the retailer, the retailer will not accept it and the bacon must be destroyed.

The bacon grease also soaks into the fiber board at the cut edges. The soaking in of the grease makes the package soggy.

The grease together with the organic fiber produces sites for mold or bacteria growth.

Fibers and paper dust from the cut can find its way to the surface of the bacon.

The films delaminate from the base board.

These problems can be completely solved with the present invention which utilizes a unique foam plastic stiffener sheet and with processing steps which seal the edges of the foam structure to assure no grease penetration into the foam structure.

The steps of manufacturing the foam sheet and package of the present invention include:

1. A sheet structure is extruded with three layers. The outside layer is a white blend of polystyrene materials to provide a smooth printable surface. The inner layer is polystyrene foam to provide the preferred stiffness and economics. The bottom layer intended to contact the bacon is a blend of polystyrene and pigment to provide the desired color.

2. The outside surface of the outside sheet is printed and a thin clear polypropylene sheet is either directly adhered to the printed surface or alternately is reversed printed and bonded to the solid polystyrene outside layer.

3. The sheet structure, printed as set forth in step 2, is then run through a heat embossing step which collapses and seals the foam structure of the inner layer in areas of the sheet that will be die cut to form (a) windows for the bacon package and (b) edges defining the outer edges of the stiffener.

4. After the embossing step, the stiffener is cut out of the extruded and printed sheet by cutting through the embossed areas to form the windows and outer edges. The cutting may be performed using a heated knife in order to assure that a seal is obtained along the cut edges so that no foam of the foam polystyrene layer is exposed at the seam in the event the heat embossing step does not totally collapse the foam to form a complete seal along the embossments. Other methods of forming a seal along the embossments may be used including laser, hot-air, plasma and induction heating or any other method of heat sealing.

Since the structure is fully sealed in the cut areas, grease cannot soak in. Additionally, dust and fibers are not present as in the fiber board products of the prior art. No delaminating is experienced with the structure of the present invention.

The embossing step can also be used to form a quilted or waffled surface which improves the stiffness and handling of the, foam stiffener and the finished bacon package.

The embossing step can also provide decorative patterns in the printed surface such as a pig outline or other desired logo shapes.

### IN THE DRAWINGS

FIG. 1 is a flow diagram showing the manufacture of foam stiffener of the present invention.

FIG. 2 is a perspective view of a section of tri-extruded foam/film as it is unrolled from a roll or web of such film.

FIG. 3 is a perspective view showing the structure of FIG. 2 following printing.

FIG. 4 is a view similar to FIG. 2 showing the application of polypropylene laminating film following printing as shown in FIG. 3.

FIG. 5 is a perspective view showing the tri-extruded foam/film with reverse printed polypropylene film laminated thereto.

FIG. 6 is a perspective view showing a pair of heated embossing rolls through which the web having the printed structure of FIG. 4 is passed to form a plurality of stiffener sheets in the web of foam/film with polypropylene film laminate.

FIG. 7 is a perspective view showing a plurality of stiffener sheets in the web after embossing and before being cut.

FIG. 8 is a perspective view of the foam stiffener sheet following the cutting step.

FIG. 9 is a schematic perspective view showing the embossed stiffener sheet being fed through a cutter.

FIG. 10 is a perspective view of a complete foam stiffener sheet following cutting with an embossed logo thereon.

FIG. 11 is a flow diagram showing the process of forming a bacon package utilizing the foam stiffener sheet of FIG. 8.

FIG. 11A is a view of the bacon pack as seen from the reverse side of FIG. 11.

FIG. 12 is a sectional view taken through a heat embossed area.

FIG. 13 is a sectional view taken through a heat embossed area following cutting to form windows.

FIG. 14 is a perspective view showing an embodiment of stiffener sheet with ribs.

### DETAILED DESCRIPTION OF THE INVENTION

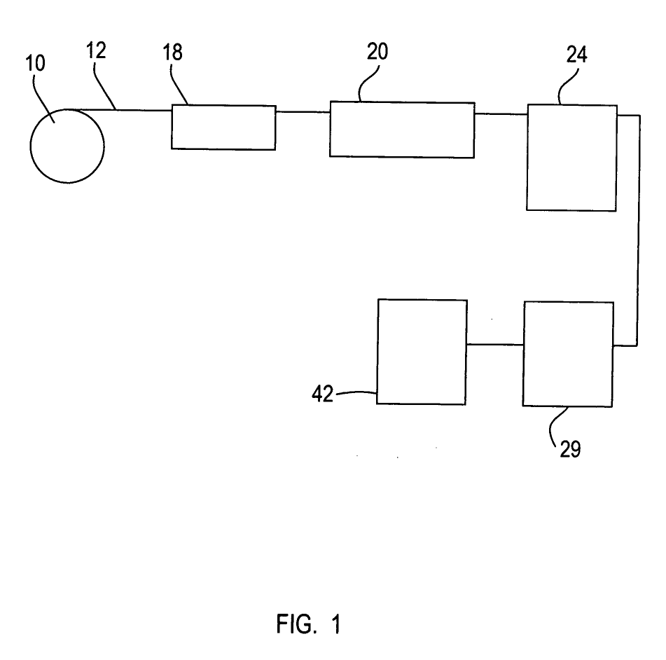

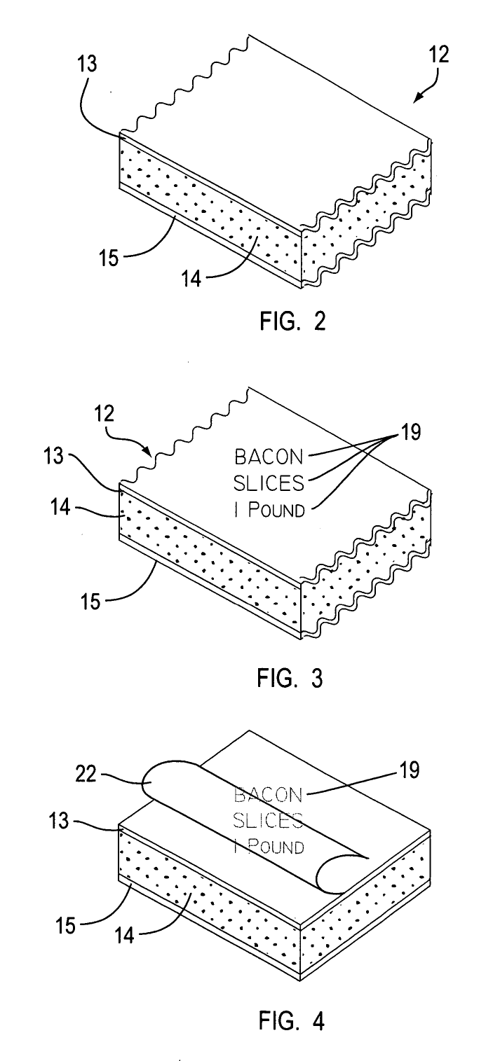

Referring to FIGS. 1-10, there is shown a roll 10 of tri-extruded foam/film being unrolled as an elongated web. The web of foam/film 12 has an outside layer 13 of solid polystyrene, preferably having a white pigment, which provides a smooth printable surface, an inner layer 14 of polystyrene foam and a bottom layer 15 of solid polystyrene intended to contact the bacon in the final bacon package. The bottom layer 15 is preferably pigmented a desired color, for example black or yellow. The overall structure of the tri-extruded foam/film has a thickness on the order of 0.015inch with the foam inner layer having a thickness on the order of 0.014 inch and each of the outside layer 13 and bottom layer 15 having a thickness on the order of 0.0005 inch.

As shown in FIG. 1, as the web of tri-extruded foam/film 12 is unrolled from the supply roll 10, it is passed through a printer 18 which prints a desired logo 19, for example, the words “BACON SLICES 1 Pound” as shown in FIG. 3.

Following printing, the tri-extruded foam/film 12 is passed through a laminator 20 which laminates a thin clear polypropylene sheet 22 over the outside layer 13 and the printed logo 19. The polypropylene sheet 22 has a thickness on the order of 0.0005 inch and provides protection for the printed logo 19 which may readily be seen therethrough.

If desired, in lieu of printing the outside layer 13, the polypropylene sheet 22 could be reverse printed on the surface which contacts the. outside layer 13. This may be seen in FIG. 5 in which the logo “BACON PACK” was reverse printed on the polypropylene film 22 prior to being laminated to the outside layer 13.

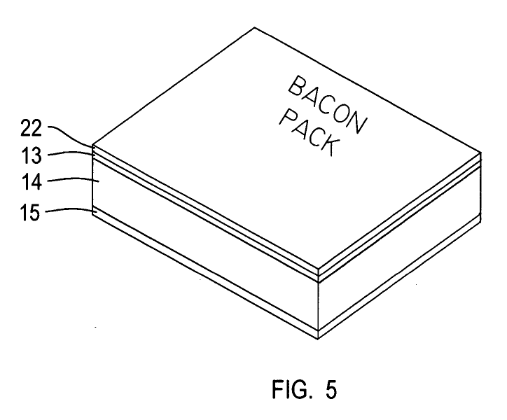

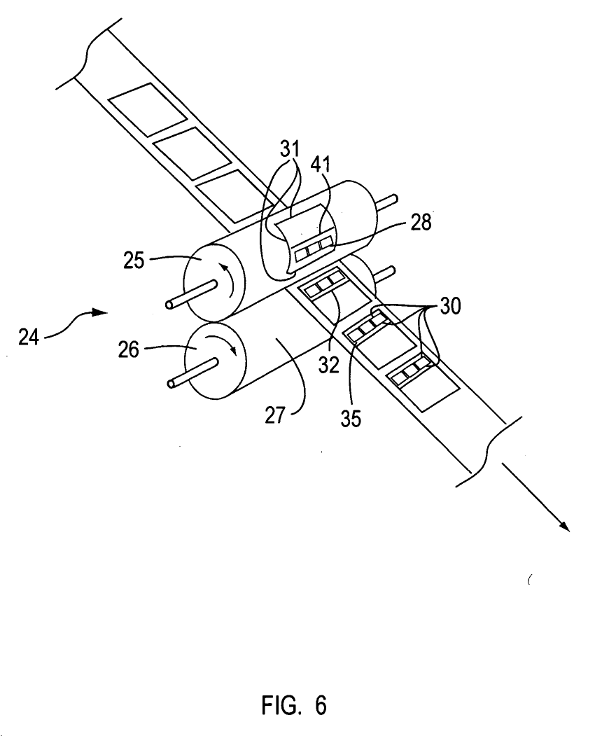

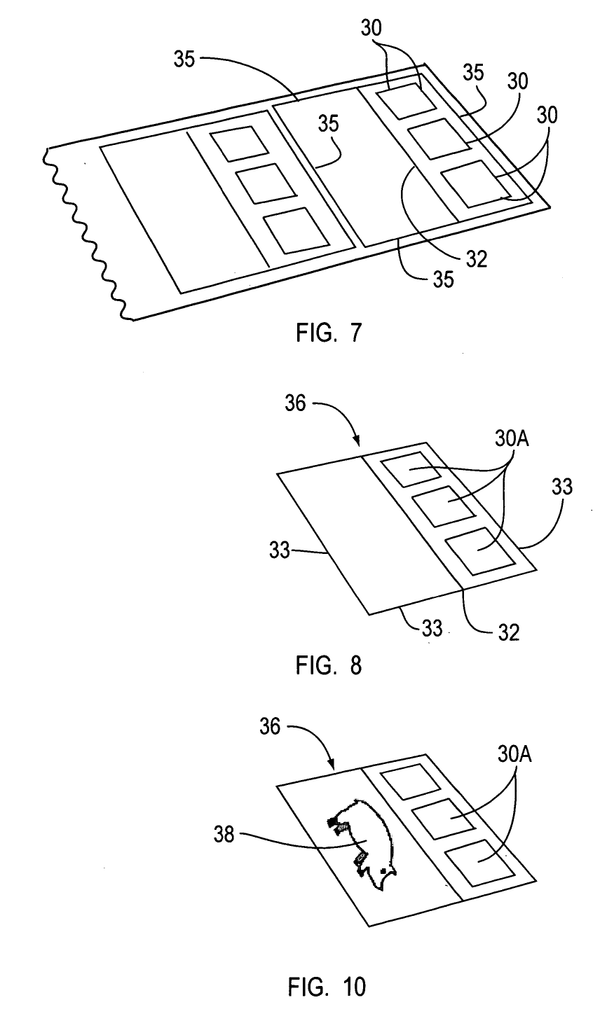

The web having the printed and laminated structure of FIG. 4 or FIG. 5 is then passed through a heat embossing station 24 having a pair of heated embossing rolls 25 and 26 such as shown in FIG. 6. As may be seen in FIG. 6, the lower roll 26 has a smooth cylindrical surface 27 while the upper roll 25 has a plurality of raised areas 28 which will compress the tri-extruded foam/film 12 with the laminated polypropylene sheet 22 to form embossed areas 30 (see FIG. 7) in which the foam is compressed to form, as a result of heat and pressure from the rolls 25 and 26, solid or mostly solid polystyrene from what was previously the foam inner layer 14. As a result, most or all portions of the embossed areas 30 are heat sealed. Additionally, the upper roll 25 has a raised area 31 defining a circumferential path 35. (See FIG. 7). The foam in this area is also compressed to form solid or mostly solid polystyrene.

The upper roll also has a transverse raised area 41 following a straight line path. The transverse raised area 41, upon embossing, forms a fold line 32 and does not necessarily form a heat seal.

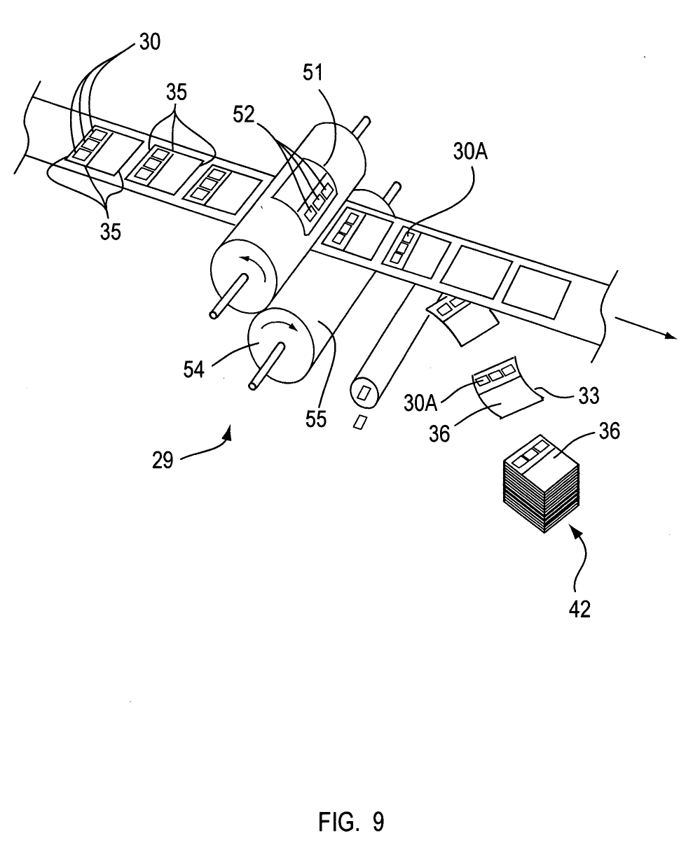

After passing through the heat embossing station 24, the embossed web is moved through a cutting station 29 (See FIG. 9) at which the web is then cut with a heated knife at a perimeter defined by the circumferential path 35 of FIG. 7 and cut, also with a heated knife, through the embossed areas 30 to form windows 30A, to form the final stiffener sheet 36 (see FIG. 8) with sealed edges 33, which stiffener sheet 36 may be then packaged for shipment to the company forming the bacon package. Cutting with heated knives assures that the perimeter edges 33 of the stiffener sheet 36 and all edges of the windows 30A are completely sealed with solid polystyrene and that there is no exposed foam at such edges. Other methods of sealing the perimeter edges 33 and the edges of the windows 30A may also be used including but not limited to laser sealing, hot-air heating, plasma heating and induction heating.

As shown in FIG. 9, the cutting station 29 includes an upper cutting roller 50 having (i) raised cutting blades 51 to cut the sealed peripheral edge defining the circumferential path 35 and (ii) raised cutting blades 52 to cut the embossed areas 30 to form windows 30A. The cutting station 29 also has a roller die anvil 54 with a smooth cylindrical surface 55 against which the cutting blades 51 and 52 cut the stiffener sheet 36 from the web. The cut stiffener sheets 36 are then delivered to a stacking station 42 for packaging and subsequent delivery to a bacon packer.

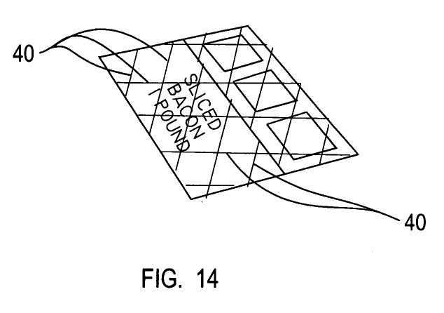

As shown in FIG. 10, if desired an additional logo 38, such as a pig, may be embossed in the stiffener sheet 36. Additionally, as shown in FIG. 14 additional stiffener ribs 40 may be embossed in the stiffener sheet 36.

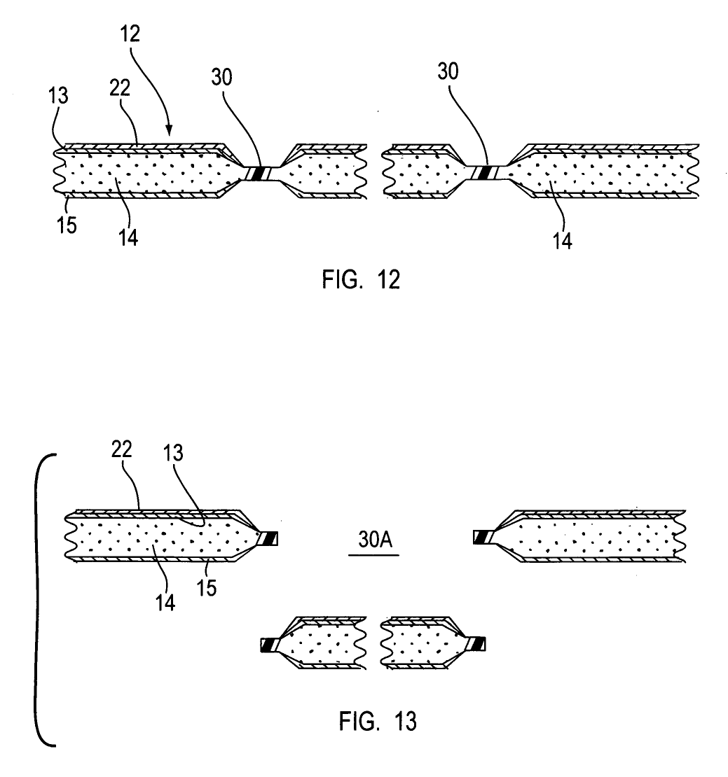

FIG. 12 is a sectional view taken through one of the embossed areas 30 to show the compression and sealing of the foam to form solid or mostly solid polystyrene in the embossed area 30. FIG. 13 is a sectional view showing circumferential embossed areas 30 cut out to form a window 30A.

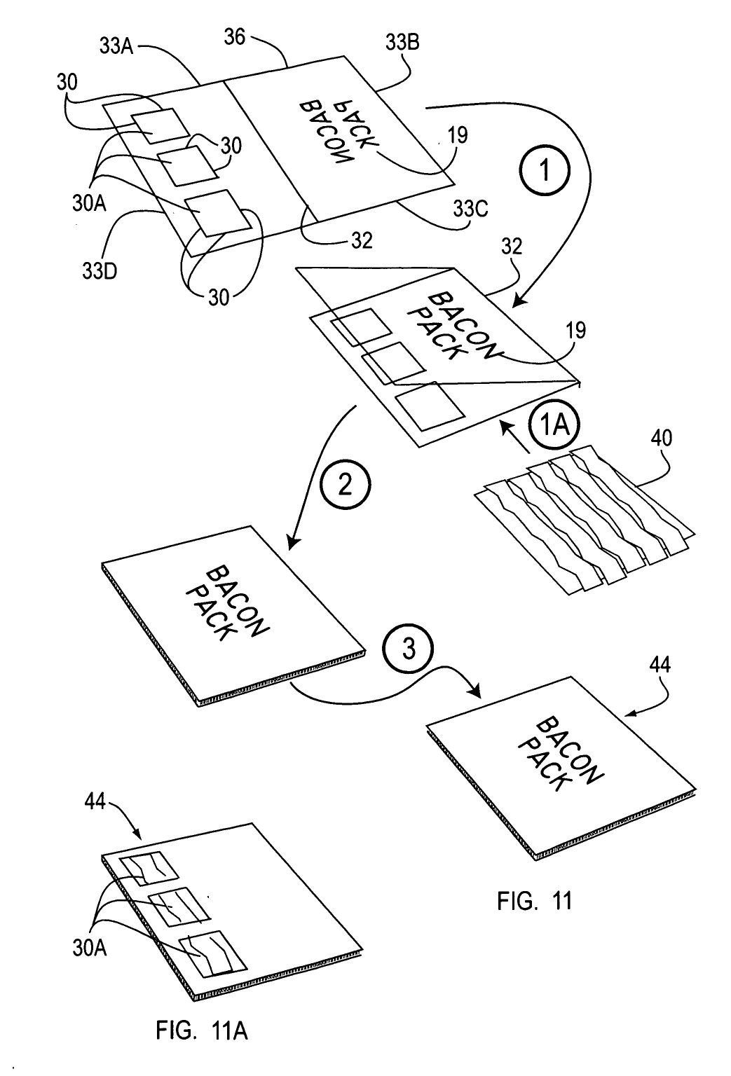

Referring to FIG. 11, there is shown schematically the process steps utilized by the bacon packer for using the stiffener sheet 36 to form the final bacon package. As shown in FIG. 11, the stiffener sheet 36 has four edges 33A, 33B, 33C and 33D, each of which was cut from an area along the circumferential path 35 which had been (1) heat compressed and sealed or (2) heat compressed and sealed by cutting with a heated knife or otherwise sealed so that the plastic at such edges is solid and no foam is exposed at such edges 33A, 33B, 33C, and 33D. Additionally, the embossed areas 30 are cut and sealed inside the embossing so that no foam is exposed at the edges of the windows 30A. Also shown is the logo 19 (“BACON PACK”), the window areas 30A, and fold line 32. As shown in FIG. 11, step (1) the stiffener sheet 36 is folded along the fold line 32 with sliced bacon positioned therein step. Step (1A) the stiffener sheet 36 folded over the bacon 40 may then be wrapped step (2),with film and vacuum packed step (3) to form the final bacon pack 44. FIG. 11A shows the bacon pack 44 on the reverse side from that shown in the flow diagram of FIG. 11. It clearly shows the defining windows 30A through which the bacon may be seen by the ultimate purchaser of the package.

Under another embodiment of the present invention, it is contemplated that a stiffener sheet could be formed using a combined cutting and sealing technique to cut the outer periphery from the web such that the outer periphery is solid plastic throughout with no foam exposed at such outer periphery. Similarly the windows could be formed within the confines of such outer periphery by using a combined step of cutting and sealing along an annular path to define an inner periphery defining each window with such inner periphery being solid plastic throughout such that no foam is exposed at such inner periphery. Such cutting and sealing could be accomplished with heated knives, laser cutting and sealing, or any other process which effects a cutting and sealing to form edges having solid plastic throughout the thickness of such edges from the outside layer 13 of polystyrene to the inner layer 14 and through the bottom layer 15.

Many modifications will become readily apparent to those skilled in the art.

1. A bacon package comprising
(a) a stiffener sheet of laminated plastic layers including an outside layer of solid polystyrene, an inner layer of foam polystyrene and a bottom layer of solid polystyrene, said stiffener sheet having one or more embossments, at least one of said embossments defining an outer perimeter of said sheet, said perimeter being solid plastic throughout;
(b) bacon; and
(c) a plastic film overwrap.

2. A bacon package according to claim 1 wherein said outside layer has laminated thereto a layer of plastic.

3. A bacon package according to claim 1 including additional embossments defining one or more windows with no plastic, each of said additional embossments being solid plastic throughout.

4. A bacon package according to claim 3 further including a straight line embossment defining a fold line, said straight line embossment being either (1) solid plastic throughout or (2) having some foam plastic.

5. A bacon package according to claim 4 wherein said straight line embossment is adjacent said windows.

6. A method of forming a stiffener sheet comprising the steps of
(a) providing a laminate of plastic including an outside layer of solid polystyrene, an inner layer of foam polystyrene and a bottom layer of solid polystyrene;
(b) heat embossing said laminate to form an embossment defining the outer periphery of said stiffener sheet, said heat embossing collapsing said inner layer of foam polystyrene to form at least partially solidified plastic in said embossment; and
(c) cutting said laminate sheet around said embossment.

7. The method according to claim 6 further including the step of printing an exposed surface of either said outside layer or said bottom layer;

8. The method according to claim 7 further including the step of laminating a clear sheet of plastic over the printed surface;

9. The method according to claim 6 further including the step of reverse printing a clear plastic film and adhering said clear plastic film to one of said layers of solid polystyrene.

10. The method according to claim 6 further including the step of heating knives used for said cutting, said knives forming a seal in the embossment defining said outer periphery.

11. The method according to claim 6 further including the step of heat embossing one or more annular embossments within the confines of said outer periphery to collapse said layer of foam plastic to form at least partially solidified plastic throughout each said annular embossment.

12. The method according to claim 11 further including the step of cutting through the thickness of said annular embossments to form windows in said stiffener sheet.

13. The method according to claim 12 further including the step of heating knives used for said cutting, said knives forming a seal in the annular embossments forming said windows.

14. The method according to claim 6 further including the step of further embossing said laminate to form a straight line embossment defining a fold line having at least partially solidified plastic.

15. A method of forming a plurality of stiffener sheets for packages comprising the steps of
(a) coexruding a laminate of plastic including an outside layer of solid polystyrene, an inner layer of foam polystyrene and a bottom layer of solid polystyrene to form a web;
(b) heat embossing discreet areas of said web to form an embossment which defines the outer periphery of a stiffener sheet, said heat embossing collapsing said inner layer of foam polystyrene to form at least partially solidified plastic throughout said embossments; and
(c) cutting said web around each said embossment.

16. The method according to claim 15 further including the step of printing an exposed surface of either said outside layer or said bottom layer;

17. The method according to claim 15 further including the step of laminating a clear sheet of plastic over the printed surface;

18. The method according to claim 15 further including the step of reverse printing a clear plastic film and adhering said clear plastic film to one of said outside or bottom layers.

19. The method according to claim 15 further including the step of heating knives used for said cutting, said knives forming a seal in the embossment defining said outer periphery.

20. The method according to claim 19 further including the step of heat embossing one or more annular embossments within the confines of said outer periphery to collapse said layer of foam plastic to form at least partially solidified plastic throughout each said annular embossment.

21. The method according to claim 20 further including the step of cutting through the thickness of said annular embossments to form windows in said stiffener sheet.

22. The method according to claim 21 further including the step of heating knives used for said cutting, said knives forming a seal in the annular embossments forming said windows.

23. The method according to claim 15 further including the step of further embossing said laminate to form a straight line embossment defining a fold line having at least partially solidified plastic.

24. A bacon package comprising
(a) a stiffener sheet of laminated plastic layers including an outside layer of solid polystyrene, an inner layer of foam polystyrene and a bottom layer of solid polystyrene, said stiffener sheet having an outer perimeter, said perimeter being solid plastic throughout such that no foam is exposed at said perimeter;
(b) bacon; and
(c) a plastic film overwrap.

25. A bacon package according to claim 24 wherein said outside layer has laminated thereto a layer of plastic.

26. A bacon package according to claim 24 further including one or more windows with no plastic, each of said widows defined by an interior perimeter having solid plastic throughout such that no foam is exposed at said perimeter.

27. A bacon package according to claim 26 further including a straight line embossment defining a fold line, said straight line embossment being either (1) solid plastic throughout or (2) having some foam plastic.

28. A bacon package according to claim 27 wherein said straight line embossment is adjacent said windows.

29. A method of forming a stiffener sheet comprising the steps of
(a) providing a laminate of plastic including an outside layer of solid polystyrene, an inner layer of foam polystyrene and a bottom layer of solid polystyrene;
(b) sealing an outer periphery of said laminate to form said stiffener sheet, said outer periphery being solid plastid throughout such that no foam is exposed at said outer periphery.

30. The method according to claim 29 further including the step of printing an exposed surface of either said outside layer or said bottom layer;

31. The method according to claim 30 further including the step of laminating a clear sheet of plastic over the printed surface;

32. The method according to claim 29 further including the step of reverse printing a clear plastic film and adhering said clear plastic film to one of said layers of solid polystyrene.

33. The method according to claim 29 further including the step of cutting along an annular path throughh the thickness of said laminate to form windows in said stiffener sheet, each said annular path being solid such that no foam is exposed.

34. The method according to claim 33 further including the step of heating knives used for said cutting, said knives forming a seal in the annular path defining said windows.

35. A method of forming a plurality of stiffener sheets for packages comprising the steps of
(a) coexruding a laminate of plastic including an outside layer of solid polystyrene, an inner layer of foam polystyrene and a bottom layer of solid polystyrene to form a web;
(b) subjecting discreet areas of said web to a combined cutting and sealing step to form an outer periphery of a stiffener sheet, said outer periphery being solid plastic throughout with no foam exposed.

36. The method according to claim 35 further including the step of printing an exposed surface of either said outside layer or said bottom layer;

37. The method according to claim 35 further including the step of laminating a clear sheet of plastic over the printed surface;

38. The method according to claim 35 further including the step of reverse printing a clear plastic film and adhering said clear plastic film to one of said outside or bottom layers.

39. The method according to claim 35 further including the step of subjecting annular areas within the confines of said outer periphery to a combined cutting and sealing step to form one or more windows, said annular areas being solid plastic throughout such that no foam is exposed.

40. The method according to claim 39 further including the step of embossing said laminate to form a straight line embossment defining a fold line having at least partially solidified plastic.
